(19) United States
(12) Patent Application Publication
(10) Pub. No.: US 2009/0157308 A1
(43) Pub. Date: Jun. 18, 2009

(54) NAVIGATION DEVICE AND NAVIGATION METHOD

(75) Inventor: Takahito Ogawa, Saitama (JP)

Correspondence Address: YOUNG & THOMPSON, 209 Madison Street, Suite 500, ALEXANDRIA, VA, 22314, US

(73) Assignee: PIONEER CORPORATION, Tokyo (JP)

(21) Appl. No.: 12/282,155

(22) PCT Filed: Mar. 6, 2007
(86) PCT No.: PCT/JP2007/054318

§ 371 Date: Nov. 10, 2008

(30) Foreign Application Priority Data
Mar. 10, 2006 (JP) 2006-066010

(51) Int. Cl. G01C 21/00

(52) U.S. Cl. 701/209

(57) ABSTRACT

It is an object of this invention to provide a navigation apparatus capable of appropriately guiding a user in an intersection and an interchange point. The navigation apparatus is preferably applicable to a navigation apparatus of a movable body such as a vehicle, and includes a display unit and a control unit. The display unit displays map information on a display screen. The control unit allocates a number to passage points in an order from the passage point near a guide point to the passage point far from the guide point, and displays the allocated number in a vicinity of the passage point on the display screen. The guide point indicates a place necessary for a user to turn right or left, and the passage point indicates a place at which turning right or left is possible and which exists between a present position of the user and the guide point. Thereby, the navigation apparatus can appropriately guide the user at the intersection and the branch point.

### TECHNICAL FIELD

The present invention relates to a navigation apparatus showing a user a route to a destination.

### BACKGROUND TECHNIQUE

Generally, a navigation apparatus displays, on a display device, map information within a predetermined range with the central focus on a present position of a movable body such as a vehicle. A user can recognize the present position of his or her own vehicle by checking the displayed map information.

The known navigation apparatus searches a route to a destination, and shows the route to the destination on the map displayed on the display screen. The user can arrive at the destination by moving in accordance with the route displayed on the display screen. However, even though the navigation apparatus shows “Turn right (or left)” on a road including a lot of intersections and branch points in a national capital region, a large number of points are shown. Thus, it is difficult for the user to recognize the point. Therefore, in a case of showing the intersection to be turned right or left, the known navigation apparatus shows a target such as a convenience store and an intersection name on the route on the display screen, and outputs a sound message, e.g., “Turn right at the third traffic signal” or “Turn left in front of a convenience store” (see Patent Reference-1).

However, in a case of guiding the user at the intersection including no target such as the convenience store and no intersection name, the above technique cannot be used. In a case of outputting the sound message, e.g., “Turn right at the third traffic signal”, it may sometimes happen that the vehicle has already passed the first traffic signal when the sound message ends. It is difficult to say that the known navigation apparatus appropriately guides the user.

Patent Reference-1: Japanese Patent Application Laid-open under No. 2003-121185

### DISCLOSURE OF INVENTION

### Problem to be Solved by the Invention

The present invention has been achieved in order to solve the above problem. It is an object of this invention to provide a navigation apparatus capable of appropriately guiding a user at an intersection and a branch point.

According to one aspect of the present invention, there is provided a navigation apparatus including: a display unit which displays map information on a display screen; and a control unit which allocates a number to passage points in an order from the passage point near a guide point to the passage point far from the guide point, and which displays the allocated number in a vicinity of the passage point on the display screen, the guide point indicating a place necessary for a user to turn right or left, the passage point indicating a place at which turning right or left is possible and which exists between a present position of the user and the guide point.

The above navigation apparatus is preferably applied to the navigation apparatus of the movable body such as a vehicle, and includes the display unit and the control unit. The display unit displays the map information on the display screen. The control unit allocates the number to passage points in the order from the passage point near the guide point to the passage point far from the guide point, and displays the allocated number in the vicinity of the passage point on the display screen. The guide point indicates the place necessary for the user to turn right or left. The passage point indicates the place at which turning right or left is possible and which exists between the present position of the user and the guide point. Thereby, the user can intuitively recognize the guide point, similarly to the explanation “Turn left at the second T-intersection”. In addition, at the intersection including few targets such as the convenience store, the user can intuitively recognize at which intersection or branch point to turn right or left. Thereby, the navigation apparatus can appropriately guide the user at the intersection and the branch point.

In a manner of the above navigation apparatus, the control unit may allocate the number to the passage points in an order from the passage point near a next guide point to the passage point far from the next guide point in such a case that the next guide point exists within a predetermined distance with respect to the guide point. Also, the control unit may display the allocated number in the vicinity of the passage point on the display screen. The passage point may exist between the guide point and the next guide point. Thereby, the user can intuitively recognize the position of the guide point even in the area including a lot of intersections and branch points in the national capital region.

In another manner of the above navigation apparatus, the control unit may delete the display of the number displayed in the vicinity of the passed passage point in such a case that the user passes the passage point. Thereby, the user can certainly recognize how many intersections and/or branch points he or she has passed with respect to the guide point. Moreover, the user does not have to gaze at the display screen.

According to another aspect of the present invention, there is provided a navigation method including: a display process which displays map information on a display screen; and a control process which allocates a number to passage points in an order from the passage point near a guide point to the passage point far from the guide point, and which displays the allocated number in a vicinity of the passage point on the display screen, the guide point indicating a place necessary for a user to turn right or left, the passage point indicating a place at which turning right or left is possible and which exists between a present position of the user and the guide point. By this method, it becomes possible to appropriately guide the user at the intersection and the branch point.

According to still another aspect of the present invention, there is provided a navigation program executed by a navigation apparatus including a computer, the navigation apparatus making the computer function as: a display unit which displays map information on a display screen; and a control unit which allocates a number to passage points in an order from the passage point near a guide point to the passage point far from the guide point, and which displays the allocated number in a vicinity of the passage point on the display screen, the guide point indicating a place necessary for a user to turn right or left, the passage point indicating a place at which turning right or left is possible and which exists between a present position of the user and the guide point. By making the computer in the navigation apparatus execute the navigation program, the above navigation apparatus can be realized. In addition, the navigation program can be used in a state of being stored in a storage medium.

### BRIEF DESCRIPTION OF THE DRAWINGS

FIG. 1 is a block diagram schematically showing a configuration of a navigation apparatus;

FIG. 2 is a flow charge of a navigation process according to a first embodiment;

FIGS. 3A and 3B show examples of display of map information in a navigation process according to the first embodiment;

FIG. 4 is a flow chart of a navigation process according to a second embodiment; and

FIG. 5 shows an example of display of the map information in the navigation process according to the second embodiment.

### BRIEF DESCRIPTION OF THE REFERENCE NUMBER

1 Navigation apparatus
22 CPU
23 ROM
24 RAM
36 Data storage unit
44 Display

### DETAILED DESCRIPTION OF THE PREFERRED EMBODIMENTS

The preferred embodiment of the present invention will now be described below with reference to the attached drawings. The explanation described below shows such an example that the present invention is applied to an on-vehicle navigation apparatus.

### (Navigation Apparatus)

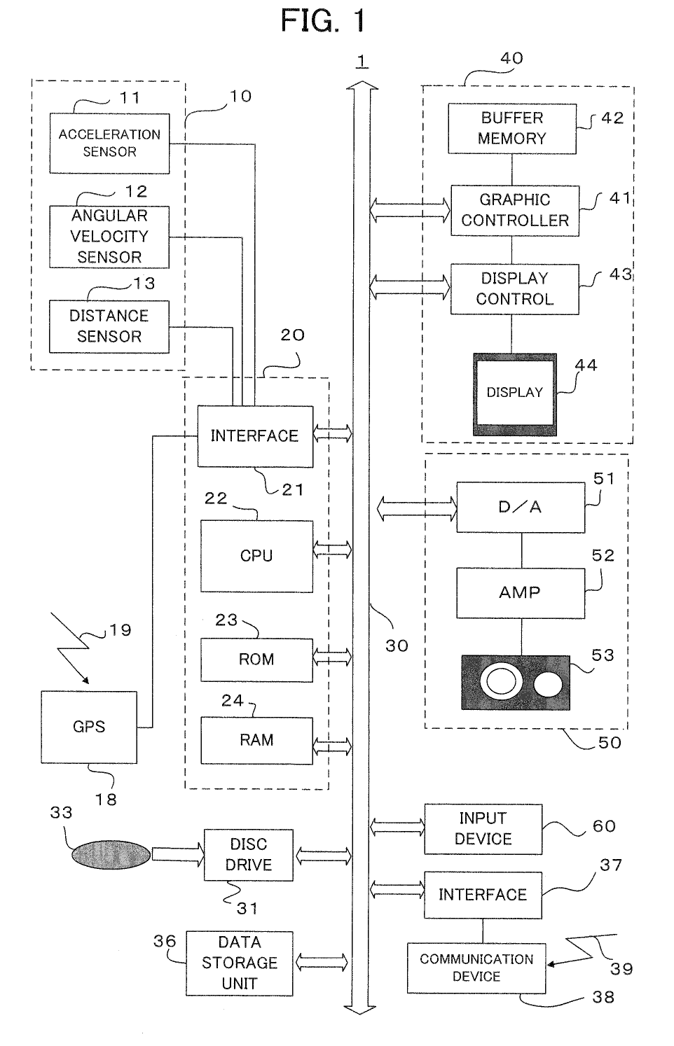

FIG. 1 shows a configuration of a navigation apparatus 1. As shown in FIG. 1, the navigation apparatus 1 includes a self position measuring device 10, a GPS receiver 18, a system controller 20, a disc drive 31, a data storage unit 36, a communication interface 37, a communication device 38, a display unit 40, a sound output unit 50 and an input device 60.

The self position measuring device 10 includes an acceleration sensor 11, an angular velocity sensor 12 and a distance sensor 13. The acceleration sensor 11, including a piezoelectric element for example, detects acceleration of the vehicle and outputs acceleration data. The angular velocity sensor 12, including vibration gyro for example, detects angular velocity of the vehicle at the time of changing of the vehicle direction and outputs angular velocity data and relative azimuth data. The distance sensor 13 measures a vehicle-speed pulse including a pulse signal generated in correspondence with the rotation of a wheel of the vehicle.

The GPS receiver 18 receives the radio wave 19 for transmitting down link data, including the position measuring data from the plural GPS satellites, which is used for detection of the absolute position of the vehicle based on the latitude information and the longitude information.

The system controller 20 includes an interface 21, a CPU (Central Processing Unit) 22, a ROM (Read Only Memory) 23 and a RAM (Random Access Memory) 24, and controls the entire navigation apparatus 1.

The interface 21 executes interface operation with the acceleration sensor 11, the angular velocity sensor 12, the distance sensor 13 and the GPS receiver 18. Then, the interface 21 inputs, to the system controller 20, the vehicle-speed pulse, the acceleration data, the relative azimuth data, the angular velocity data, the GPS positioning data and the absolute azimuth data. The CPU 22 controls the entire system controller 20. The ROM 23 includes a nonvolatile memory (not shown) in which the control program for controlling the system controller 20 is stored. The RAM 24 readably stores various kinds of data such as route data preset by the user via the input device 60, and supplies a working area to the CPU 22.

The system controller 20, the disc drive 31 such as a CD-ROM drive or a DVD-ROM drive, the data storage unit 36, the communication interface 37, the display unit 40, the sound output unit 50 and the input device 60 are mutually connected to each other via a bus line 30.

Under the control of the system controller 20, the disc drive 31 reads contents data such as sound data and video data from the disc 33 such as a CD or a DVD to output it. The disc drive 31 may be one of the CD-ROM drive and the DVD-ROM drive, or may be a compatible drive for CD and DVD.

The data storage unit 36, formed by HDD for example, is a unit which stores various kinds of data used for the navigation process, such as map data and facility data. The map data will be described in details, later.

The communication device 38 is formed by an FM tuner, a beacon receiver, a mobile phone and a dedicated communication card, for example. The communication device 38 receives road traffic information, e.g., traffic jam information and traffic information, and other information, which are delivered from a VICS (Vehicle Information Communication System) center via the communication interface 37.

Under the control of the system controller 20, the display unit 40 displays various kinds of display data on the display screen of a display. Concretely, the system controller 20 reads out the map data from the data storage unit 36, and the display unit 40 displays, on the display screen of the display, the map data read out from the data storage unit 36 by the system controller 20. The display unit 40 includes a graphic controller 41 for controlling the entire display unit 40 on the basis of the control data transmitted from the CPU 22 via the bus line 30, a buffer memory 42 including a memory such as a VRAM (Video RAM) and temporarily storing the picture information instantly displayable, a display control unit 43 for executing display control of a display 44 such as liquid crystal display and a CRT (Cathode Ray Tube) on the basis of the picture data outputted from the graphic controller 41, and the display 44. The display 44 includes a liquid crystal display device having a diagonal length of substantially 5-10 inches, for example, and it is mounted on the vicinity of a front panel in the vehicle.

The sound output unit 50 includes a D/A (Digital to Analog) converter 51 for executing D/A conversion of the sound digital data transmitted from the CD-ROM drive 31 or the DVD-ROM 32, or from the RAM 24 via the bus line 30 under the control of the system controller 20, an amplifier (AMP) 52 for amplifying a sound analog signal outputted from the D/A converter 51, and a speaker 53 for converting the amplified sound analog signal to the sound to output it into the vehicle.

The input device 60 includes keys, switches, buttons, a remote controller and a sound input device for inputting various kinds of commands and data. The input device 60 is arranged on a front panel of a main body of an on-vehicle electronic system mounted on the vehicle and around the display 44. In addition, in such a case that the display 44 is formed in a touch panel system, the touch panel provided on the display screen of the display 44 also functions as the input device 60.

In the navigation apparatus of the present invention, the display device 44 functions as a display unit. Additionally, when the CPU 22 of the navigation apparatus 1 executes the program stored on the ROM 23, the navigation apparatus of the present invention can be realized. Therefore, the CPU 22 functions as the control unit in the present invention.

### First Embodiment

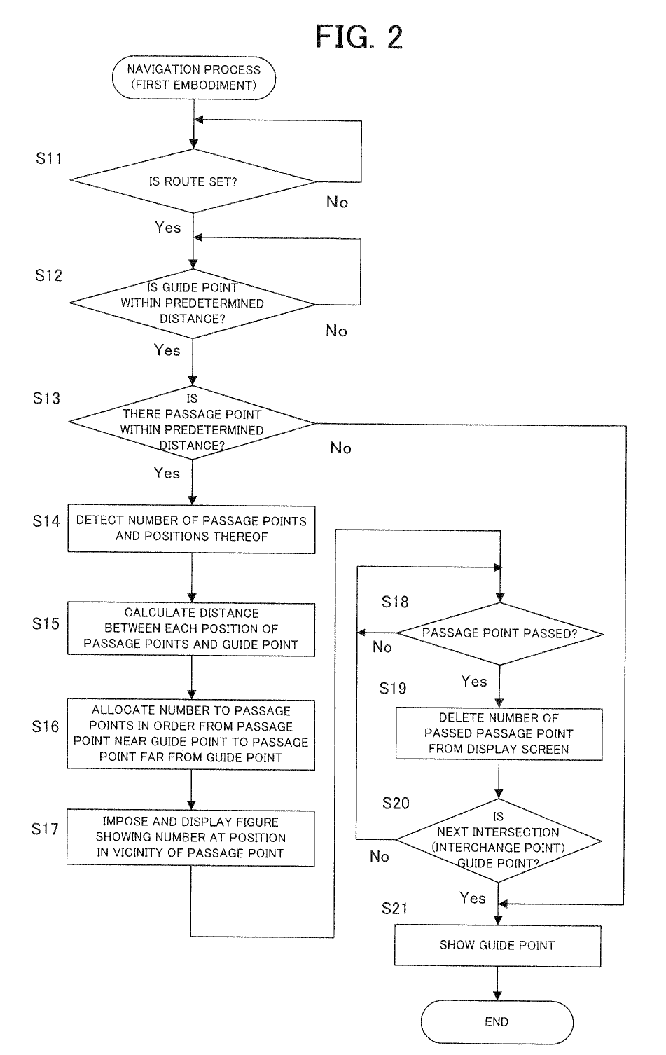

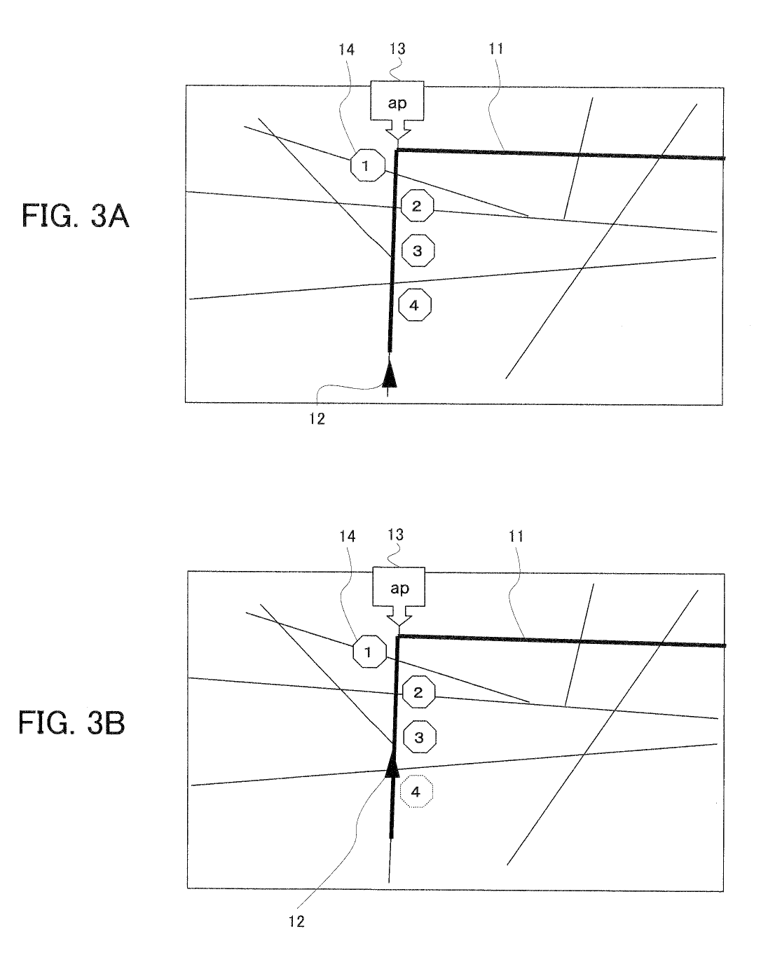

A description will be given of a method of the navigation process executed by the navigation apparatus according to a first embodiment. FIG. 2 is a flow chart showing the navigation process according to the first embodiment. FIGS. 3A and 3B show examples of map information shown on the display screen of the display 44 in each process of the navigation process according to the first embodiment.

First, the CPU 22 determines route set, i.e., whether or not the user sets the destination and the route to the destination is set (step S11). The CPU 22 continues this operation until the route setting is completed (step S11; No).

Now, the concrete method of the route setting will be simply explained. When the route is set, the user sets the destination by operating the input device 60, and inputs the route search instruction to the navigation apparatus 1. The CPU 22 reads necessary link and node information from the data storage unit 36 to calculate the route. Then, the CPU 22 stores not only the necessary map information but also the route information in the buffer memory 42 to display them on the display screen of the display 44. Thereby, the map information and the route information are displayed on the display screen.

When determining that the route is set (step S11; Yes), the CPU 22 determines whether or not the distance from the present position of the user to a guide point is within the predetermined distance (step S12). The guide point is the intersection and/or branch point at which the user has to change the course by turning right or left. The CPU 22 continues this operation until it determines that the distance to the guide point is within the predetermined distance (e.g., within 700 m) (step S12; No).

When determining that the distance from the present position of the user to the guide point is within the predetermined distance (step S12; Yes), the CPU 22 determines whether or not the passage point exists within the predetermined distance, i.e., from the present position of the user to the guide point (step S13). The passage point is the intersection and/or branch point at which turning right or left is possible and which the user goes straight on and passes through. Concretely, with using the stored node information, the CPU 22 determines whether or not the passage point exists. When the CPU 22 determines that no passage point exists within the predetermined distance (step S13; No), the process goes to step S21.

When determining that the passage point exists within the predetermined distance (step S13; Yes), the CPU 22 detects the number of passage points and the positions thereof (step S14), and calculates the distance between each of the passage points and the guide point (step S15).

Based on the calculated distance value, the CPU 22 allocates the number to the passage points in the order from the passage point near the guide point to the passage point far from the guide point (step S16), and imposes and displays the number at the position in the vicinity of the correspondent passage point on the display screen (step S17).

FIG. 3A shows the display screen shown in the manner. In FIG. 3A, a heavy line 11 shows the set route, and a triangle-shaped arrow 12 shows the present position of the user. A position shown by an idea balloon ap shows the position of the guide point, and numbers surrounded by hexagon-shaped frames 14 show the numbers allocated to the passage points. As shown in FIG. 3A, the numbers are allocated to the positions of the intersections (numbers 1, 2 and 4) and the branch point (number 3), which are the passage points between the present position of the user shown by the triangle-shaped arrow 12 and the guide point shown by the idea balloon ap.

The CPU 22 determines the number of numbers displayed based on the distance to the guide point, the number of passage points and the scale of the present map information, and displays the numbers in the size which does not prevent display of other display objects.

Next, the CPU 22 determines whether or not the user has passed the passage point (step S18). The CPU 22 continues this operation until it determines that the user has passed the passage point (step S18: No). When determining that the user has passed the passage point (step S18: Yes), the CPU 22 deletes the passed passage point number from the display screen (step S19). FIG. 3B shows this state. In the example shown in FIG. 3B, since the user has already passed the passage point “4” to which the number “4” is allocated, the CPU 22 deletes the number “4”.

Next, the CPU 22 determines whether or not the next intersection or branch point is the guide point (step S20). When the CPU 22 determines that the next intersection or branch point is not the guide point, the process returns to step S18 (step S20: No). Namely, the CPU 22 repeats the operation of steps S18 and S19 until the user passes through all the passage points to the guide point. Whenever the user passes through the passage point, the CPU deletes the passed passage point number from the display screen.

When the CPU 22 determines that the next intersection or branch point is the guide point (step S20: Yes), the process goes to step S21.

When the present position reaches the position in the vicinity of the guide point in step S21, the CPU 22 gives a course change instruction to the user by outputting the sound guide “Turn right at the next intersection” or by enlarging and displaying the intersection or branch point of the guide point on the display screen. Afterward, the CPU 22 ends the process.

As understood from the above explanation, in the navigation apparatus according to the first embodiment, the CPU 22 allocates the number to the passage points in the order from the passage point near the guide point to the passage point far from the guide point. At this time, the guide point indicates the place necessary for the user to turn right or left, and the passage point indicates the place at which turning right or left is possible and which exists between the present position of the user and the guide point. Further, the CPU 22 displays the allocated number in the vicinity of the passage point on the display screen. Thereby, the user can intuitively recognize the guide point, similarly to the explanation “Turn left at the second T-intersection”. Also, even at the intersection including few landmarks such as the convenience store, the user can intuitively recognize which intersection or branch point to turn right or left. In this method, the navigation apparatus can appropriately guide the user at the intersection and the branch point.

In addition, in the navigation apparatus 1 according to the first embodiment, the CPU 22 deletes the display of the number displayed in the vicinity of the passed passage point when the user has passed the passage point. In this manner, by the countdown display of the figure, the user can certainly recognize how many intersections and/or branch points he or she has passed with respect to the guide point, and he or she does not have to gaze at the display screen carefully.

### Second Embodiment

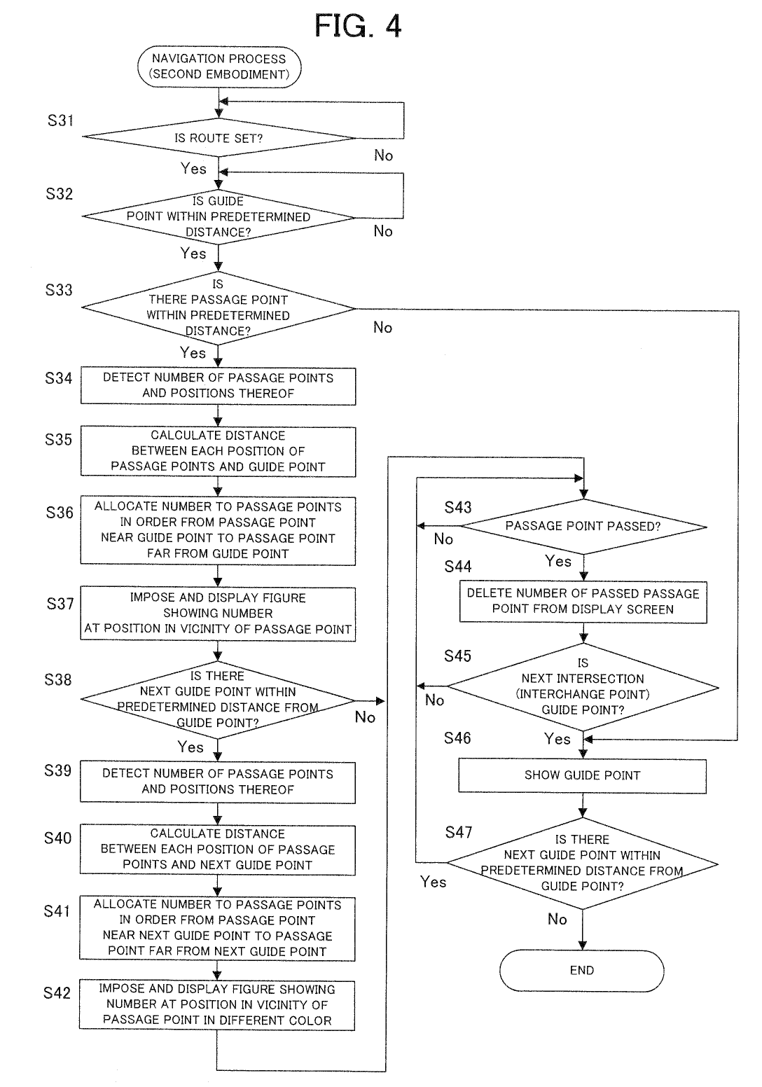

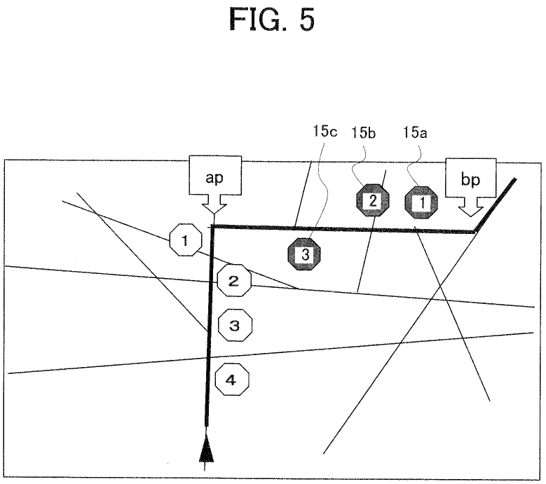

Next, a description will be given of the navigation process executed by the navigation apparatus according to a second embodiment. FIG. 4 is a flow chart of the navigation process according to the second embodiment, and FIG. 5 shows an example of the map information shown on the display screen of the display 44 in each process of the navigation process according to the second embodiment.

The operation of the CPU 22 in steps S31 to S37 and step S46 is same as that of the CPU 22 in steps S11 to S17 and S21 in the first embodiment.

The CPU 22 imposes and displays the number at the position in the vicinity of the correspondent passage point in step S37, and determines whether or not the next guide point exists in the predetermined distance from the guide point (step S38). When the CPU 22 determines that the next guide point does not exist within the predetermined distance from the guide point (step S38: No), the process goes to step S43. Meanwhile, when determining that the next guide point exists within the predetermined distance from the guide point, the CPU 22 detects the number of passage points from the guide point to the next guide point and the positions thereof (step S39). Then, the CPU 22 calculates the distance between each of the passage points and the next guide point (step S40).

Based on the calculated distance value, the CPU 22 allocates the number to the passage points in the order from the passage point near the next guide point to the passage point far from the next guide point (step S41), and imposes and displays the number at the position in the vicinity of the correspondent passage point on the display screen in the color different from that of the number shown in step S37 (step S42).

FIG. 5 shows the display screen displayed in this manner. A position shown by an idea balloon bp shows the position of the next guide point, and the figures surrounded by hexagon-shaped frames 15a, 15b and 15c show the numbers shown in step S42. As understood from FIG. 5, the numbers are allocated to the passage points between the guide point shown by the idea balloon ap and the next guide point shown by the idea balloon bp, i.e., the positions of the intersections (numbers 1 and 2) and the branch point (number 3).

Next, the CPU 22 determines whether or not the user has passed the passage point (step S43). The CPU 22 continues the operation until the CPU 22 determines that the user has passed the passage point (step S43: No). When determining that the user has passed the passage point (step S43: Yes), the CPU 22 deletes the number of the passed passage point from the display screen (step S44).

Next, the CPU 22 determines whether or not the next intersection or branch point is the guide point (step S45). When the CPU 22 determines that the next intersection or branch point is not the guide point, the process returns to step S43 (step S45: No). Namely, the CPU 22 repeats the operation in steps S43 to S44 until the user passes all of the passage points up to the guide point. Whenever the user passes the passage point, the CPU 22 deletes the number of the passed passage point from the display screen.

When the CPU 22 determines that the next intersection or branch point is the guide point (step S45: Yes), the process goes to step S46.

In step S46, when the present position reaches the position in the vicinity of the guide point, the CPU 22 instructs the user to change the course by outputting the sound guidance “Turn right at the next intersection” or by enlarging and displaying the intersection or branch point of the guide point on the display screen.

Afterward, the CPU 22 determines whether or not the next guide point exists within the predetermined distance with respect to the guide point (step S47). When the CPU 22 determines that the next guide point exists within the predetermined distance with respect to the guide point, the process returns to step S43. Whenever the user passes the passage point between the guide point and the next guide point, the CPU 22 deletes the number of the passage point. Meanwhile, when the CPU 22 determines that the next guide point does not exist within the predetermined distance with respect to the guide point, the process ends.

As described above, in the navigation apparatus according to the second embodiment, when the next guide point exists within the predetermined distance with respect to the guide point, the CPU 22 allocates the number to the passage points in the order from the passage point near the next guide point to the passage point far from the next guide point. At this time, the passage point indicates the place at which turning right or left is possible and which exists between the guide point and the next guide point. Further, the CPU 22 displays the allocated number in the vicinity of the passage point on the display screen. Thereby, even in such a case that there are a lot of intersections and branch points and the distance between the guide points is short in the national capital region, the user can intuitively recognize the position of the guide point. Thereby, the navigation apparatus can appropriately guide the user at the intersection and the branch point.

Additionally, in the navigation apparatus 1 according to the second embodiment, when the user passes the passage point, the CPU 22 deletes the display of the number displayed in the vicinity of the passed passage point. Thereby, the user can certainly recognize how many intersections and/or branch points he or she has passed with respect to the guide point. At the same time, the user does not have to gaze at the display screen.

As described in the above first and second embodiments, the navigation apparatus according to the present invention includes the display unit which displays the map information on the display screen; the control unit which allocates the number to the passage points in the order from the passage point near the guide point to the passage point far from the guide point, and which displays the allocated number in the vicinity of the passage point on the display screen, the guide point indicating the place necessary for the user to turn right or left, the passage point indicating the place at which turning right or left is possible and which exists between the present position of the user and the guide point. Thereby, the user can intuitively recognize the position of the guide point. In this manner, the navigation apparatus can appropriately guide the user at the intersection and branch point.

### [Modification]

In the above embodiments, the passage point is prescribed as the intersection or branch point at which turning right or left is possible, but the present invention is not limited to this. Instead, the passage point may be the intersection or branch point including a traffic signal. Thereby, it becomes possible to reduce the number of numbers to be displayed on the display screen.

In the above embodiments, the navigation apparatus allocates the number to the passage points, but the present invention is not limited to this, either. Instead, from a word associated with the order, e.g., “I-RO-HA-NI-HO-HE-TO . . . ” or “ABCD . . . ”, one character may be allocated to the passage points one by one to be displayed.

Further, in the above embodiments, when the user passes the passage point, the navigation apparatus deletes the display of the number displayed in the vicinity of the passed passage point, but the present invention is not limited to this, either. Instead, in the vicinity of the display of such a large intersection that has its own name, the navigation apparatus may display the number of passed passage points until the user reaches the guide point from the large intersection, e.g., “The number of intersections to be passed is 3”.

Moreover, the navigation apparatus of the present invention is not limited to an on-vehicle navigation apparatus. Instead, the navigation apparatus of the present invention may be realized by executing a program in a mobile phone and PDA (Personal Digital Assistants) having a GPS function and capable of displaying the map information.

### INDUSTRIAL APPLICABILITY

This invention is applicable to a navigation apparatus of a movable body such as a vehicle.

1. A navigation apparatus comprising:
a display unit which displays map information on a display screen; and
a control unit which allocates a number to passage points in an order from the passage point near a guide point to the passage point far from the guide point, and which displays the allocated number in a vicinity of the passage point on the display screen, the guide point indicating a place necessary for a user to turn right or left, the passage point indicating a place at which turning right or left is possible and which exists between a present position of the user and the guide point.

2. The navigation apparatus according to claim 1, wherein the control unit allocates, for the passage points existing between the guide point and a next guide point, the number to the passage points in an order from the passage point near the next guide point to the passage point far from the next guide point in such a case that the next guide point exists within a predetermined distance from the guide point, and the control unit displays the allocated number in the vicinity of the passage point on the display screen.

3. The navigation apparatus according to claim 1, wherein the control unit deletes the display of the number displayed in the vicinity of the passed passage point when the user passes the passage point.

4. A navigation method comprising:
a display process which displays map information on a display screen; and
a control process which allocates a number to passage points in an order from the passage point near a guide point to the passage point far from the guide point, and which displays the allocated number in a vicinity of the passage point on the display screen, the guide point indicating a place necessary for a user to turn right or left, the passage point indicating a place at which turning right or left is possible and which exists between a present position of the user and the guide point.

5. A computer program product in a computer-readable medium executed by a navigation apparatus comprising a computer, the navigation apparatus making the computer function as:
a display unit which displays map information on a display screen; and
a control unit which allocates a number to passage points in an order from the passage point near a guide point to the passage point far from the guide point, and which displays the allocated number in a vicinity of the passage point on the display screen, the guide point indicating a place necessary for a user to turn right or left, the passage point indicating a place at which turning right or left is possible and which exists between a present position of the user and the guide point.

6. A recording medium which records the navigation program according to claim 5.
